(19) United States
(12) Patent Application Publication
(10) Pub. No.: US 2008/0195458 A1
(43) Pub. Date: Aug. 14, 2008

(54) Dynamic Selection and Incorporation of Advertisements

(76) Inventors: Thomas Anschutz, Conyers, GA (US); Alan Blackburn, Woodstock, GA (US); Edgar Shrum, Smyrna, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/611,400

(22) Filed: Dec. 15, 2006

(51) Int. Cl. G06Q 30/00; G06Q 10/00

(52) U.S. Cl. 705/10; 705/14

(57) ABSTRACT

Advertisements are dynamically selected for incorporation into programs utilizing information about available spots and demographics associated with a program. An individual consumer may view or hear advertisements which have been incorporated into the program. The consumer can rate the advertisements and/or programs, and the information is tracked, possibly modifying the way advertisements are selected in the future. Advertisers may be given the opportunity to bid for advertising rights for particular demographic categories of consumers watching particular programs.

### CROSS-REFERENCE TO RELATED APPLICATIONS

This application is related to the co-pending U.S. application having Ser. No. 11/610,588 entitled “Media Content Alteration,” filed on Dec. 14, 2006, and having Attorney Docket No. HBH 60027.5027US01/BLS 060210. This application is also related to the co-pending U.S. application having Ser. No. 11/609,004, entitled “Rule-Based Contiguous Selection and Insertion of Advertising,” filed on Dec. 11, 2006 and having Attorney Docket No. HBH 60027.5030US01/BLS 060343.

### TECHNICAL FIELD

This application relates generally to advertising. More particularly, this application relates to dynamically selecting advertising for media programs.

### BACKGROUND

Advertisers have an increasingly difficult job in trying to target the right advertisement in the right format to the right consumer. The number and diversity of media outlets constantly increases, making finding the right consumer more and more difficult. With regard to content-based advertising, such as media advertisement spots, advertisers have previously had to gamble on buying spots during programs, attempting to target consumers based on an approximated demographic profile for each program. The media advertisement spots, including spots during video, audio, and other programming, may incorporate an audio or video advertisement into or between portions of the program. In the end, the advertiser has to assume that the spot aired and touched the intended targets. Although advertisers can reach a select audience using these spots, it produces an inexact result, and only some portion of the actual audience may be the intended target of the advertisement spot.

In addition to the problems of targeting the right consumers, the growing popularity of digital video recorders (DVRs) and other digital recording devices has made the job of advertisers all the more difficult. With DVRs and MP3 players, a consumer will frequently fast forward through advertising. Using the current media advertising paradigm, no matter how successfully targeted an advertisement may be, it is difficult for an advertiser to tell how many and who actually perceived their advertisement. Currently, televisions, radios, computers and other media devices provide little or no feedback to the advertisers. Did the consumer find the advertisement effective? Is the consumer interested in purchasing the product or service advertised? These questions are currently left unanswered, except perhaps by inexact surveys and/or focus groups. Ultimately, purchasing advertisement spots is a gamble based on demographic guessing, further complicated by consumer technology. It would be useful for advertisers to be able to specifically target the right consumers, and to receive and utilize some amount of feedback about consumers who actually perceived the advertisements.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to embodiments described herein, methods and systems provide for selecting advertisements for incorporation into a program. Spot information describing advertisement spots available in the program and demographic information describing a plurality of consumers of the program are received, along with advertisement information for available ads. A set of selected advertisements is determined using the spot, demographic and advertisement information. The selected advertisements are incorporated into the program for playback to a consumer. Two consumers may perceive different advertisements for the same program. Advertisers may bid on advertisement spots prior to selecting the advertisements.

According to further embodiments of the invention, computer-readable media provide computer-executable instructions, which when executed provide for receiving requests for the same program from different consumers. Each consumer, having different demographic profiles, receive the same program but with different advertisements, according to the information stored in the separate demographic profiles.

Other systems, methods, and/or computer program products according to embodiments will be or become apparent to one with skill in the art upon review of the following drawings and Detailed Description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating an example of a computing device in which one or more embodiments may be implemented;

FIGS. 2 and 3 are block diagrams depicting examples of dynamic advertising selection systems according to one or more embodiments;

FIGS. 4A-4F are video displays depicting examples of dynamically selected advertisements according to one or more embodiments;

FIG. 5 is a table depicting an advertising selection bid summary according to one or more embodiments; and

FIG. 6 is a flow diagram depicting a process for dynamically selecting advertisements according to one or more embodiments.

### DETAILED DESCRIPTION

The following detailed description is directed to methods, systems, and computer-readable media for dynamically selecting advertisements for incorporation into a program. In the following detailed description, references are made to the accompanying drawings that form a part hereof, and which are shown, by way of illustration, using specific embodiments or examples. Referring now to the drawings, in which like numerals represent like elements through the several figures, aspects of the methods and systems provided herein will be described.

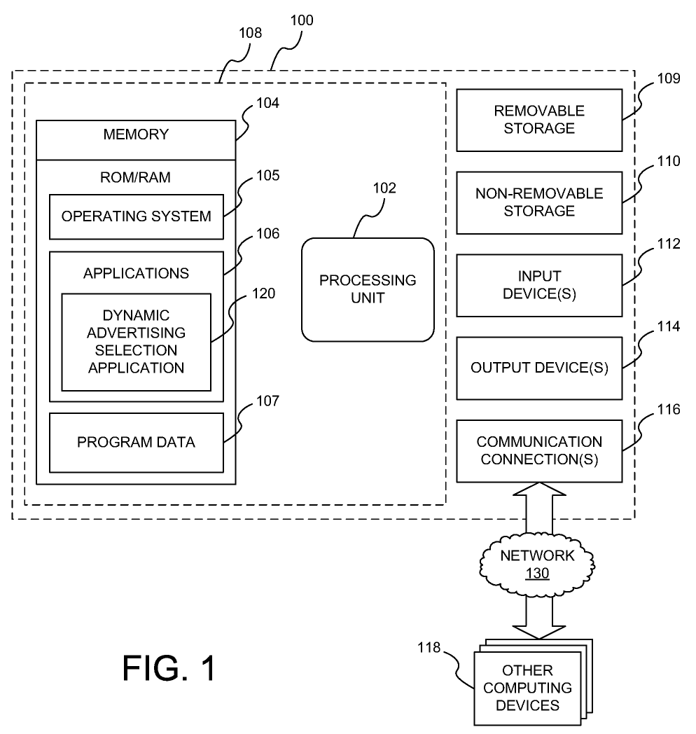

FIG. 1 and the following discussion are intended to provide a brief, general description of a suitable computing environment in which embodiments of the invention may be implemented. While embodiments of the invention will be described in the general context of program modules that execute in conjunction with an application program that runs on an operating system on a computer system, those skilled in the art will recognize that other embodiments of the invention may also be implemented in combination with other program modules.

Generally, program modules include routines, programs, components, data structures, and other types of structures that perform particular tasks or implement particular abstract data types. Moreover, those skilled in the art will appreciate that embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a network. In a distributed computing environment, program modules may be located in both local and remote memory storage devices.

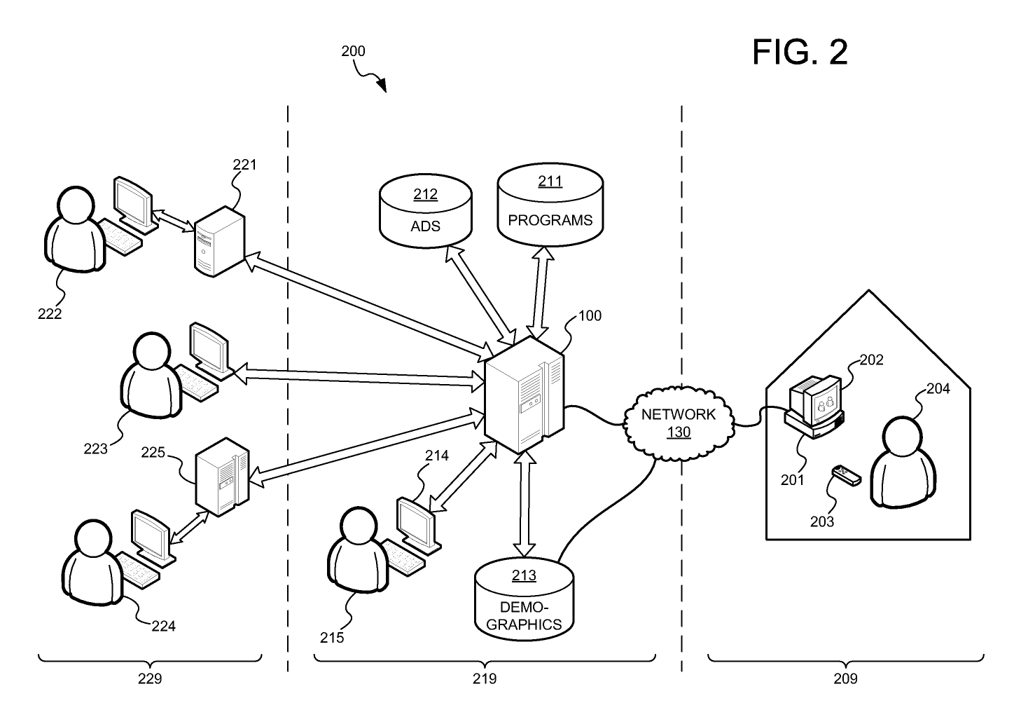

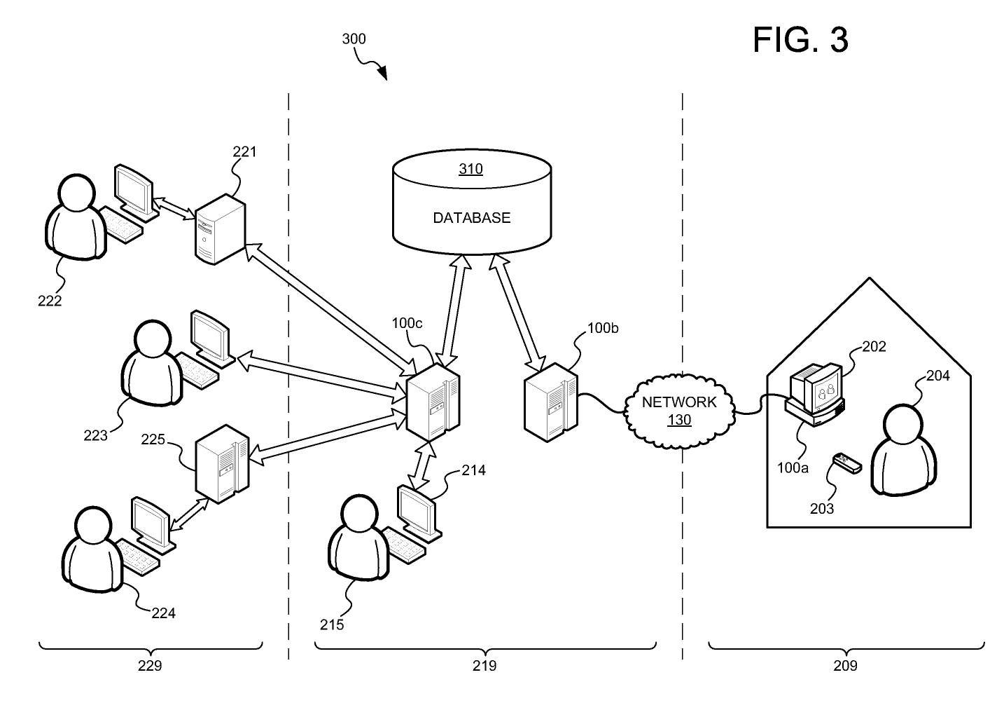

With reference to FIG. 1, embodiments of the invention may include a computing device, such as a computing device 100. In a basic configuration shown in FIG. 1, the computing device 100 includes at least one processing unit 102 and a memory 104. Multiple processors may accompany the processing unit 102. Depending on the configuration of the computing device 100, the memory 104 may be volatile (e.g., Random Access Memory (RAM)), non-volatile (e.g., Read-Only Memory (ROM), flash memory), or some combination thereof. The memory 104 serves as a storage location for an operating system 105, one or more applications 106, and may include program data 107, as well as other programs and data. In various embodiments, the applications 106 include a dynamic advertising selection application 120, an application including similar logic, or any other set of instructions comprising such logic. It should be noted that the logic of the dynamic advertising selection application 120 may be distributed and/or shared across multiple computing devices. More information regarding the function of the dynamic advertising selection application 120 is provided below in the description of FIGS. 2 and 3.

The computing device 100 may include additional features and functionality other than the features shown within dashed-line box 108. For example, the computing device 100 may include additional data storage components, including both removable storage 109 (e.g., floppy disks, memory cards, compact disc (CD) ROMs, digital video discs (DVDs), external hard drives, universal serial bus (USB) drives) and non-removable storage 110 (e.g., magnetic hard drives).

Computer storage media may include media implemented in any method or technology for storage of information, including computer readable instructions, data structures, program modules, or other data. The memory 104, the removable storage 109, and the non-removable storage 110 are all examples of computer storage media. Further examples of computer storage media include RAM, ROM, electrically-erasable programmable ROM (EEPROM), flash memory, CD-ROM, DVD, cassettes, magnetic tape, and magnetic disks. Any such computer storage media may be accessed by components which are a part of the computing device 100, or which are external to the computing device 100 and connected via a communications link (e.g., Bluetooth®, USB, parallel, serial, infrared). The computing device 100 may also include one or more input devices 112 for accepting user input. Examples of input devices 112 include a keyboard, mouse, digitizing pen, microphone, touchpad, touch-display, and combinations thereof. Similarly, the computing device 100 may include one or more output devices 114 such as displays, speakers, printers, and combinations thereof. It should be understood that the computing device 100 may also include additional forms of storage, input, and output devices. The input devices 112 and the output devices 114 may include communication ports and associated hardware for communicating with external input and output devices rather than including the devices with the computing device 100.

The computing device 100 may also include one or more communication connections 116 that include hardware and/or software which enable the computing device 100 to communicate with other computing devices 118 over a network 130. The network 130 may include a wireless network such as, but not limited to, a Wireless Local Area Network (WLAN) such as a WiFi network, a Wireless Wide Area Network (WWAN), a Wireless Personal Area Network (WPAN) such as Bluetooth®, a Wireless Metropolitan Area Network (WMAN) such as a WiMAX network, a cellular network, or a satellite network. Alternatively, the network 104 may be a wired network such as, but not limited to, a wired Wide Area Network (WAN), a wired (Local Area Network) LAN such as the Ethernet, a wired Personal Area Network (PAN), or a wired Metropolitan Area Network (MAN). Communication media, in the form of computer readable instructions, data structures, program modules, or other data in a modulated data signal, may be shared with and by the computing device 100 via the communication connection 116. A modulated data signal may mean a signal that has one or more of its characteristics set or changed in such a manner as to encode information in the signal, and may include a modulated carrier wave or other transport mechanism.

Turning now to FIG. 2, a dynamic advertising selection system 200 according to one or more embodiments will be described. It should be noted that the dynamic advertising selection systems 200 and 300 of FIGS. 2 and 3 represent two illustrative examples of systems according to the disclosure presented herein. Other systems and configurations may be assembled which fall within the breadth and scope of the claims. The dynamic advertising selection system 200 dynamically selects advertisements for inclusion in a program for playback to a consumer 204. The advertisements may be selected for the consumer 204 based on a demographic profile of the consumer 204, and other information about the available advertisement slots and the program as will be described below. As a result, two neighbors may see and/or hear different advertisements during the course of the same program.

A program may be any form of streamed audio and/or visual information. Examples of programs include, but are not limited to, radio programs, cable or Internet Protocol television (IPTV) programs, Internet videos, Internet audio, and satellite radio programs. Programs may be digitally stored in one or more storage locations, such as a programs database 211, or may be broadcast live, such as a live sporting event, for example. An advertisement can be any type of commercial and/or promotional media incorporated into a program, and may itself incorporate visual, audible, and other elements. Advertisements may be stored in one or more storage locations, such as within an advertisement database 212. An advertisement spot represents one or more opportunities to incorporate an advertisement into a program. Examples of advertisement spots include, but are not limited to, commercials, overlay animations, overlay logos, product placements, brand placements, program guide placements, product announcements, and host endorsements. The consumer 204 is any person capable of perceiving an advertisement.

The system 200 is divided into multiple domains including a consumer domain 209, an operator domain 219, and a third party domain 229. The consumer domain 209 includes one or more playback devices 201 and 202 for receiving and playing programs and advertisements for the benefit of one or more consumers 204. The consumer 204 may or may not utilize a remote 203 to control the playback devices 201 and 202. The operator domain 219 includes one or more devices for receiving, storing, and transmitting programs and advertisements. The devices may include servers, including the computing device 100, one or more databases 211, 212, and 213, and a terminal 214 operated by an operator analyst 215. The third party domain 229 includes one or more third party participants 222, 223, and 224, each of which may work with a computer including one or more servers 221 and 225 when creating and/or distributing programs and advertisements. The third party participants 222, 223, and 224 may represent individuals or organizations including programming networks, content producers, and advertisers, for example. Each of the domains 209, 219, and 229 is discussed in more detail below.

When programs are made available for distribution, as part of, for instance, an on-demand distribution scheme, or as part of a scheduled broadcast scheme, they may be received at the computing device 100 from one or more program providers 224 such as a broadcast network, a website, or an independent producer via the provider server 225, for example. The received programs are then stored in the programs database 211. Additional information about the programs, including but not limited to, title, episode, credits, actors, actresses, plot summary, genres, links to websites, transcripts/scripts, music information, and other data about the program may optionally be received and stored in the programs database 211. The program information may be received in place of the program itself, where the program information includes a reference or link to a source of the program. The program information may optionally be generated by an operator analyst 215, for example, upon receipt and storage of the program in situations where the program information is not provided by the program provider 224. Other third parties, including, for example, movie, television, or music information database websites, may also source program information for a particular program.

Information about one or more advertisement spots available for incorporating advertisements into a program may also be received and stored along with the program information in a database such as the programs database 211. Advertisement spot information may include a real estate size (e.g., 1/16 of a screen, ¼ of a screen), a length of time for display, a type of advertisement spot (e.g., audio announcement, static logo, animated overlay, and an integrated advertisement), a time within the respective program, a minimum resolution, and other information about the available spot. More examples of advertisement spots are provided below. Advertisement spot information may alternatively or additionally be generated by the operator analyst 215, especially for programs that do not automatically allow for advertisement spots (e.g., movies not made for television). The operator analyst 215 may also, for example, augment supplied advertisement spot information, creating more advertisement spots. For example, initially a video program may have gaps available for video commercials, but the operator analyst 215 may add advertisement spot information to create, for example, an additional animated overlay advertisement opportunity. The operator analyst 215 may further create advertisement spots such as, for example, presenting sponsor spots or integrated advertisement spots.

Similar to what occurs with programs, advertisements available for selection and information about the advertisements may be received at the computing device 100 from one or more advertisers 222 and 223 and stored in a database, such as the advertisement database 212. As noted above, advertisements can include any media to be used to fill the one or more advertisement spots in a program. Advertisements may include, but are not limited to, audio and/or video commercials, static or animated graphics, logos, and tag lines. Advertisement information may include, but is not limited to, company, product or service, links to more information, credits, actors, genres, scripts, music information, logos and graphics, geographic limitations, expiration dates, targeted demographic information and other data about the stored advertisements available for selection. Alternatively, advertisement information may be received from the advertisers 222 and 223 in place of the advertisements themselves, where the advertisement information includes a reference or link to a stored location for the advertisement.

According to implementations described herein, targeted demographic information may include a prioritized list of demographic categories to which the associated advertisement is to be targeted. Targeted demographic information related to a specific advertisement may be stored in a database, such as the advertisement database 212 or the demographic database 213. The targeted demographic information for any advertisement may include demographics targeted by the advertisement, as well as a demographic history for who has perceived the advertisement. Demographic information associated with the advertisement may further include information about whether the customer 204 who perceived the advertisement liked it and/or wanted more information. As with programs, feedback may be delivered from the playback devices 201 and 202 to the demographic database. The playback devices 201 and 202 in the example of FIG. 2 constitute a set top box 201 or DVR working in concert with a television 202 or display of some type. Other playback devices may include computers, radios, monitors, MP3 players, smart phones, and other electronic devices capable of playing back a program.

Examples of feedback include a review of a particular advertisement, as well as exclusions of categories of advertisements, for example, beer and liquor advertisements. Feedback may also include merely fast forwarding through a commercial signaling disapproval, or replaying a commercial signaling approval. Feedback from the customer 204 may be provided using the remote control 203, or other feedback mechanisms. Feedback may be aggregated and utilized in the selection of advertisements for entire demographic populations. Feedback may also be utilized to select or exclude advertisements for the customer 204 based on the previously provided feedback of the customer 204.

Additional information about demographics associated with a particular program may further be received and stored in a database, such as the program database 211 or the demographic database 213. The demographic database 213 may store multiple types of expected demographic information associated with a particular program. For example, before a program airs, an estimate of the expected demographic breakdown of the program's audience may be provided by third party participants such as program producers or research firms. For example, this expected demographic information may include a breakdown of demographics and a number of expected viewers for each demographic category. For example, a new program is expected to draw approximately 56 thousand men between the ages of 18 and 34 located in the Southeastern United States. These estimated demographic values may be estimates based broadly on the subject matter of the show, or based on certain actors or actresses, critical reviews, as well as the history of demographic viewership for the program or other similar programs. Demographic categories may include, but are not limited to, geographic location, gender, age, race, religious faith, income, preferred or disfavored actors and/or program genres, and other identifiable or self-identified categories or labels associated with a customer such as the customer 204.

Once a program airs, expected demographic estimates may be replaced or augmented by realistic or actual demographic viewership. Realistic viewership estimates may be based on ratings as provided by, for example, NIELSEN MEDIA RESEARCH. Alternatively, actual demographic viewership may be determined based on the information provided in the form of feedback by the playback devices 201 and 202 located at the premises of the consumer 204. The playback devices 201 and 202 may report what was viewed and/or heard, when, and by whom for collection in a database such as the demographic database 213. Furthermore, the actual demographic information stored may be utilized to more precisely predict the expected viewership of future airings of the same program, or similar programs.

The dynamic advertising selection application 120 executing on the computing device 100 may utilize the targeted demographic information, the advertisement spot information, and the advertising information (including the expected demographic information) to select advertisements for demographic categories and/or select advertisements for specific individuals. Selected advertisements are selected to fill the available advertisement spots in a particular program for playback to the customer 204 or a category of customers. Different types of advertisements may be utilized to fill different types of advertisement spots. For example, in a video context, a presenting sponsorship may include a color logo and a recording of a jingle to be played when announcing the presenting sponsorship. In an audio context, the presenting sponsorship may merely require the jingle.

In selecting advertisements for individuals or demographic categories watching a particular program, the dynamic advertising selection application 120 may utilize the demographic profiles of the users, the expected demographic information, the advertisement spot information, and the advertising information in concert to determine a best set of advertisements for the program. If 35 to 54 year old women in the Western United States, for example, prefer humorous advertisements for fashion accessories based on feedback, then such advertisements may be weighted as having a preference for that demographic. The term weight may simply mean a straight up selection of the advertisement for the target. Alternatively, the complexity of matching advertisements to available advertisement spots for a given program and a given customer or demographic category may be ameliorated by utilizing a system of weights for various preferences or demographics. The dynamic advertising selection application 120 may also infer preferences based on known demographic preferences. For example, if advertisements for fashion accessories are preferred, then designer clothing advertisements may be weighted as being preferred since the products may be considered as being related. For such a selection technique, inferred preferences may be weighted lower than known preferences.

Selections may be further augmented by utilizing the program information, especially when working with users having unknown demographic profiles. Based on the expected demographic information for a particular program, advertisements may be weighted based on their appeal to users having demographic profiles matching the expected demographics of the particular program. For example, if viewers of an animated program are predominantly young, then advertisements may be weighted and selected based on that match, especially when the demographic profile of the customer 204 is not available to the dynamic advertising selection application 120.

Once determined, the dynamic advertising selection application 120 may incorporate selected ads into the program for media playback for the customer 204. In some embodiments, the incorporation of advertisements may take place at the computing device 100. In the context of a video program, a video commercial may simply be inserted at a point in time identified by the advertisement spot information for the program. In the case of an overlay animation, the images of the video program may be modified directly. For example, if the video program is encoded utilizing a Motion Picture Experts Group-4 standard (MPEG-4), overlay animations may be added programmatically as a new layer, object, or collection of still frames into the video program. In this fashion, the computing device 100 may create several different versions of the program, some targeted for individuals, others targeted for demographic categories, for example. The work of incorporating advertisements into programs may, however, be delegated to other more-specialized or dedicated devices.

In determining selections, the advertisers 222 and 223 may play a more direct role by bidding for available advertisement slots. One advertiser 222 may interface directly with a bidding system via a web interface, for example, in order to bid for the opportunity to target particular individuals or demographic categories for a particular program. Another advertiser 223 may utilize an automated proxy running on the server 221 in order to participate in the bidding process. Regardless, based on the winners of bids for particular spots in particular programs, the targeted viewers or listeners may only perceive those advertisements of winners who bid for the right to target them. More information regarding an example of a bidding system is provided below.

Similar to FIG. 2, FIG. 3 depicts an additional embodiment of the dynamic advertising selection system 300. As noted above, other additional embodiments of the dynamic advertising selection system may be available. Here, the multiple storage locations 211, 212, and 213 of FIG. 2 are replaced with a single database 310, for use in storing any needed information, programs, and/or advertisements. Rather than utilizing a single computing device 100, the responsibilities of the dynamic advertising selection application 120 have been divided among three computing devices 100a, 100b, and 100c. Each of the computing devices 100a, 100b, and 100c may perform a portion of the operations constituting the dynamic advertising selection application 120. The computing device 100c may, for example, coordinate the receipt and storage of program information, advertisement spot information, advertisement information, as well as programs and advertisements. The computing device 100c may also coordinate communications with the third party participants 222, 223, and 224, including any bidding activities.

The computing device 100b may, for example, query the database 310 for all of the relevant information for a particular program and make the final selection of advertisements for the program chosen for playback by the customer 204. The computing device 100b may also be responsible for receiving and storing demographic information and/or feedback associated with actual consumers perceiving the program. The computing device 100a displayed in FIG. 3 may be the set top box 201 and may, for example, perform the incorporation of the selected advertisements into the program. This may include dynamically modifying the media streams making up the program to add the advertisements. In order to incorporate advertisements into programs, the computing device 100a may download the programs and advertisements from the database 310, or from the servers 221 and 225 of third parties via the network 130.

The computing device 100a may receive multiple sets of advertisements (or references or links to advertisements) for the different potential demographics which may be viewing the program. For example, in a multi-consumer household, the set top box may identify the current consumer 204 and select the appropriate advertisement set based on the current viewer. In a situation where multiple household members are listening to a radio program, for example, the computing device 100a may, for example, blend the provided sets of advertisements and select the superset of the most universally acceptable advertisements. The computing device 100a may also track and forward feedback information to the computing device 100b. Tracking feedback includes tracking whether advertisements were skipped, whether the advertisements were replayed, as well as any on-the-fly ratings provided by the consumer 204 via the remote 203. Feedback may also include tracking the types of programming preferred by the consumer 204.

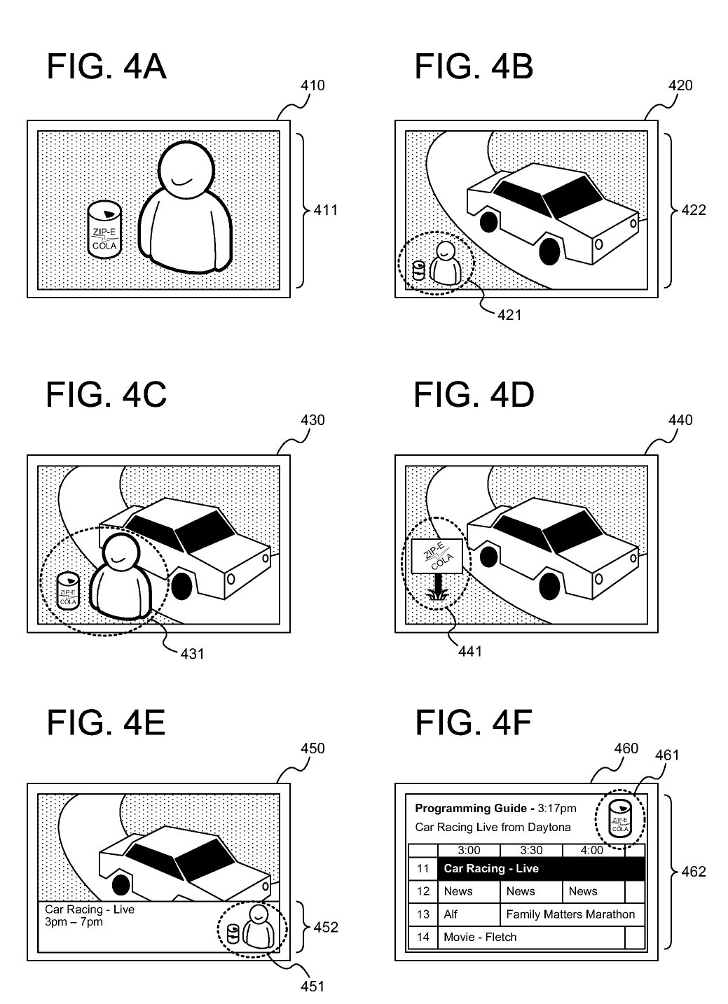

Turning now to FIGS. 4A-4F, each of the similar figures depicts a video display showing an example of an advertisement incorporated into a program. Each figure utilizes the same or similar images, but incorporates the images in different ways, utilizing different sizes. FIG. 4A depicts a video display 410 showing a full-screen commercial 411, one which interrupts the underlying program. FIG. 4B depicts a video display 420 showing a program 422 with a small corner overlay advertisement 421. The overlay advertisement 421 may or may not be animated, and may use the same underlying images as the larger commercial 411. FIG. 4C depicts a video display 430 showing a larger corner overlay advertisement 431. Presumably, the larger advertisement is more valuable, but may obstruct the action as it does here.

FIG. 4D depicts a video display 440 showing the program 422, but this time the advertisement, a roadside signpost within the program, has been incorporated as an integrated advertisement 441. As shown, an integrated advertisement 441 may include incorporating an advertisement apparently into the media stream, making it a part of the program. One or more complex calculations may be used to create this effect, but basically a portion of the underlying program is replaced or overwritten with the integrated advertisement 441. Other examples of an integrated advertisement may include changing the brands on a box of cereal or a can of soda depicted in the current program.

FIG. 4E depicts a video display 450 showing on-screen information 452 and an on-screen information advertisement 451. Here, a portion of the on-screen information for the current program is controlled by the advertiser. Such advertisements which would only appear in the situation where the user requests the on-screen information may require detailed tracking and feedback in order to guarantee that the advertiser only pays for consumers who actually view the advertisement 451.

FIG. 4F depicts a video display 460 showing an electronic program guide 462 and a program guide advertisement 461. The program guide advertisement 461 may change automatically depending on the currently selected program in the electronic program guide 462. The program guide advertisement 461 may also change depending on the currently selected network or programming source. The program guide advertisement 461 may include a static image, animated graphics, a promotional video, an audio announcement, and other types of advertisements.

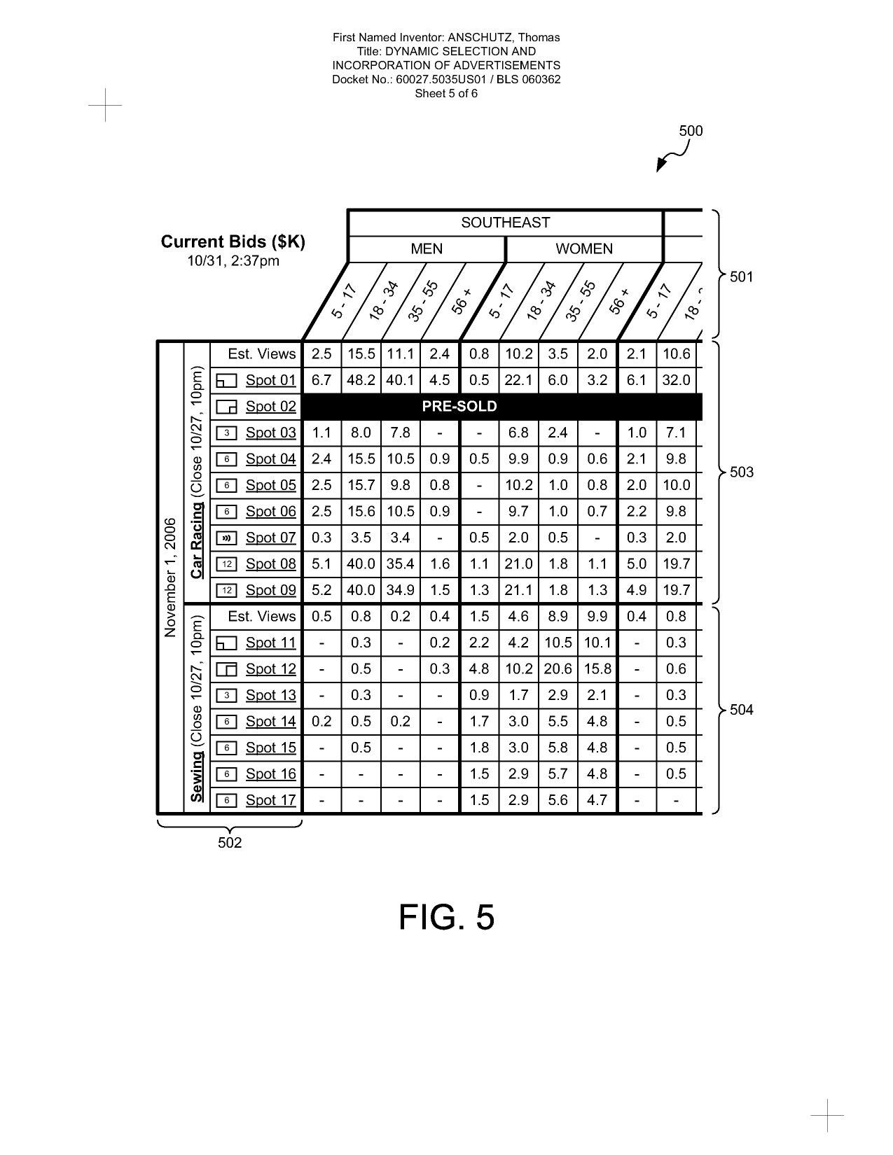

FIG. 5 is a table 500 depicting an example of an advertising selection bid summary. The table 500 may be an interface for summarizing the current bid amounts 503 and 504 for advertising spots 502 for various programs, and across various demographics 501. The advertisers 222 and 223 who interact with the dynamic advertising selection application 120 via a bidding interface may utilize a table similar to the table 500. The table may be interactive, including links to additional information about one or more current bids, a set of demographic categories, programs, and available advertising spots. The advertising spots 502 may include icons symbolizing the types of advertising spots that are available for a program. Some spots may be pre-sold prior to bidding, as with Spot 02. This may be the result of a long-term contract, or perhaps is reserved by the operator or a third party (e.g., a network) for promotional use.

Bids for particular advertising spots 502, or groups of advertising spots, may be solicited using various forms of auctions, or other methods. For example, bidding advertisers may submit bids simultaneously without seeing the bids that others are submitting, as in a sealed first-price auction. The highest initial bid wins the spot. Bidding advertisers may alternatively be alerted to the bids of their competitors, as in an English or open auction, and therefore be given an opportunity to respond with a more aggressive offer. Bidding advertisers may be provided with electronic updates as bid prices escalate via email or instant messages, enabling a particular advertiser to outbid a competitor in real time. Whether live, such as via a teleconference, or online, multiple forms of auctions or other bidding mechanisms may be used to solicit bids for or otherwise sell advertising spots.

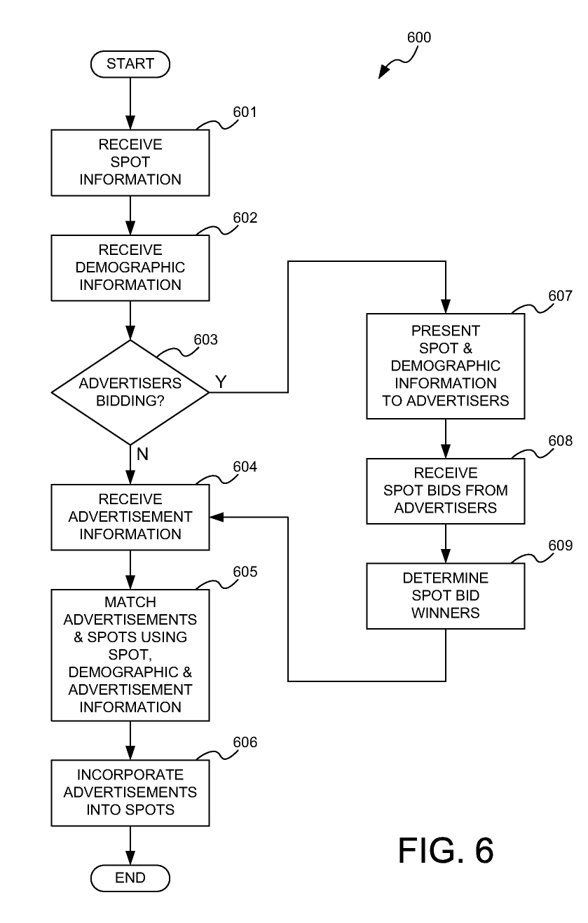

FIG. 6 is a flow diagram depicting a process 600 for dynamically selecting advertisements according to one or more embodiments. Such a process may be implemented on one or more computing devices 100, and may include the functionality of the dynamic advertising selection application 120. The logical operations of the various implementations presented, may be (1) a sequence of computer implemented acts or program modules running on one or more computing devices 100 and/or (2) interconnected machine logic circuits or circuit modules within the computing device 100. The implementation is a matter of choice dependent on the performance requirements of the computing device 100 on which the embodiments are implemented. Accordingly, the functional operations making up the implementations are referred to variously as operations, structural devices, acts, or modules. It will be recognized by one skilled in the art that these operations, structure devices, acts, and modules may be implemented in software, in firmware, in special purpose digital logic, and/or any combination thereof without deviating from the spirit and scope of the attached claims. Moreover, it will be apparent to those skilled in the art that the operations described may be combined, divided, reordered, skipped, and otherwise modified, also without deviating from the spirit and scope of the attached claims.

The process 600 begins with operation 601, where the dynamic advertising selection application 120 receives advertising spot information for a program. The advertising spot information may be provided along with the program, or may be generated or modified by the operator of the dynamic advertising selection application 120. The advertising spot information may be stored in the database 212. At operation 602, the dynamic advertising selection application 120 receives expected demographic information associated with the program. The demographic information may be the expected number of consumers for each of a set of demographic categories, or the demographic information may constitute the demographics of the consumers 204 who are actually currently watching or listening to the program.

At decision 603, the dynamic advertising selection application 120 determines if advertisers will be bidding on the spots for one or more programs. This may be determined based on how many advertisement spots have been pre-sold or otherwise been manually reserved. If enough advertisement spots have been already committed, then bidding may be unnecessary or not valuable. Otherwise, the decision may be determined based on a lack of bidders, for example. If no bidding occurs, then advertisement information about the advertisements available for selection and incorporation is received by the dynamic advertising selection application 120 at operation 604. At operation 605, advertisements are matched with available advertisement spots in the program using the advertisement spot, demographic, and advertisement information. At operation 606, the selected advertisements are then incorporated into the available advertisement spots for playback by the consumer 204.

Returning to decision 603, if the dynamic advertising selection application 120 does allow advertisers to bid for available advertising spots, then at operation 607, the advertisement spot information and the demographic information is presented to the bidders 222 and 223, or possibly software on a server 221 acting as a proxy for a bidder 222. Bids for various combinations of demographic categories and advertising spots are received at operation 608, and at operation 609, the winners of the bidding are selected. At this point, the dynamic advertising selection application 120 returns to operation 604 where the advertisement information is received, possibly from the winning advertisers, and operation continues normally as before.

Although the subject matter presented herein has been described in conjunction with one or more particular embodiments and implementations, it is to be understood that the invention defined in the appended claims is not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for selecting advertisements for incorporation into a program, the method comprising:
receiving spot information describing an advertisement spot associated with the program;
receiving demographic information describing at least one consumer of the program;
receiving advertisement information associated with a plurality of potential advertisements; and
selecting an advertisement from the plurality of potential advertisements utilizing the advertisement information, the demographic information, and the spot information, the advertisement corresponding to the advertisement spot.

2. The method of claim 1, further comprising directing that the advertisement be incorporated into the program for playback to the at least one consumer of the program.

3. The method of claim 2, wherein directing that the advertisement be incorporated into the program comprises incorporating the advertisement into a programming guide.

4. The method of claim 1, further comprising receiving feedback from the at least one consumer of the program, the feedback associated with one of the set of selected advertisements.

5. The method of claim 4, wherein selecting the advertisement from the plurality of potential advertisements further comprises utilizing the feedback from the at least one consumer of the program.

6. The method of claim 1, further comprising:
receiving program information associated with the program; and
selecting the advertisement from the plurality of potential advertisements further utilizing the program information.

7. The method of claim 1, wherein selecting the advertisement from the plurality of potential advertisements comprises:
presenting the spot information and the demographic information to a plurality of advertisers;
receiving a plurality of spot bids from the plurality of advertisers, wherein the plurality of advertisers utilize the demographic information and the spot information to make spot bids;
determining a spot winner from the plurality of spot bids; and
selecting the advertisement from the plurality of potential advertisements based on the advertisement information and the spot winner.

8. The method of claim 1, wherein receiving spot information describing the advertisement spot associated with the program comprises receiving a spot type of the advertisement spot.

9. A system selecting advertisements for incorporation into a program, the system comprising:
means for receiving spot information describing an advertisement spot associated with the program;
means for receiving demographic information describing at least one consumer of the program;
means for receiving advertisement information associated with a plurality of potential advertisements; and
means for selecting an advertisement from the plurality of potential advertisements utilizing the advertisement information, the demographic information, and the spot information, the advertisement corresponding to the advertisement spot.

10. The system of claim 9, further comprising means for directing that the advertisement be incorporated into the program for playback to the at least one consumer of the program.

11. The system of claim 10, wherein directing that the advertisement be incorporated into the program for playback comprises directing that the advertisement be incorporated into a programming guide.

12. The system of claim 9, further comprising means for receiving feedback from the at least one consumer of the program, the feedback associated with the advertisement.

13. The system of claim 12, wherein means for selecting the advertisement from the plurality of potential advertisements further utilizes the feedback.

14. The system of claim 9, further comprising:
means for receiving program information associated with the program; and
means for selecting the advertisement from the plurality of potential advertisements further utilizing the program information.

15. The system of claim 9, wherein means for selecting the set of advertisements from the plurality of potential advertisements comprises:
means for presenting the spot information and the demographic information to a plurality of advertisers;
means for receiving a plurality of spot bids for the advertisement spot from the plurality of advertisers, wherein the plurality of advertisers utilize the demographic information and the spot information to make spot bids;
means for determining a spot winner from the plurality of spot bids; and
means for selecting the advertisement from the plurality of potential advertisements based on the advertisement information and the spot winner.

16. The system of claim 9, wherein means for receiving spot information describing the advertisement spot associated with the program comprises means for receiving a spot type of the advertisement spot.

17. A computer-readable medium storing computer-executable instructions, which when executed by a computer, perform a method comprising:
receiving a first request from a first consumer to playback the program, wherein the first consumer is characterized by a first demographic profile;
responding to the first request by selecting a first set of advertisements to incorporate into the program, the first set of advertisements selected based on information about available advertisement spots and the first demographic profile;
receiving a second request from a second consumer to playback the program, wherein the second consumer is characterized by a second demographic profile; and
responding to the second request by selecting a second set of advertisements to incorporate into the program, the second set of advertisements selected based on the information about available advertisement spots and the second demographic profile.

18. The computer-readable medium of claim 17, wherein the executing computer-executable instructions further perform the method comprising:
presenting information about the first and second demographic profiles along with information about the available advertisement spots to a plurality of bidders;
receiving a plurality of bids for the available advertisement spots; and
determining a plurality of bid winners from the plurality of bids.

19. The computer-readable medium of claim 17, wherein the executing computer-executable instructions further perform the method comprising:
receiving program information associated with the program; and
selecting the first set of advertisements from the plurality of potential advertisements further utilizing the program information.

20. The method of claim 5, wherein receiving program information associated with the program comprises receiving the program information from a program provider.
